(19) United States
(12) Patent Application Publication
(10) Pub. No.: US 2004/0187302 A1
(43) Pub. Date: Sep. 30, 2004

(54) Tire-rimming device for toy cars

(76) Inventor: Daimler Chu, Taipei (TW)

Correspondence Address: Daimler Chu, PO Box 82-144, Taipei, TW

(21) Appl. No.: 10/397,802

(22) Filed: Mar. 27, 2003

(51) Int. Cl. B23P 19/00

(52) U.S. Cl. 29/802

(57) ABSTRACT

A tire-rimming device for a toy car is disclosed. The device comprises a base seat within a housing and a pressing frame, characterized in that the base seat is provided with a support frame, a rotating plate, a fastening seat and a switch, the center of the rotating plate is provided with a positioning shaft which is connected to a speed-reduction motor within the housing. The axle of the speed-reduction motor is engaged with that of the rotating plate, thereby when the tire is placed on the rotating plate, the pressing frame will press down and lock the tire in position. The protruded lug on the bottom edge of the pressing frame can separate the rim from the tire, so that when the power is on, the speed-reduction motor will be actuated to drive the rotating plate, and therefore ease applying the adhesive to the tire.

### BACKGROUND OF THE INVENTION

(a) Technical Field of the Invention

The present invention relates to a tire-rimming device, and in particular to one for installing a rim onto a tire of a toy car or onto a similar structure.

(b) Description of the Prior Art

Various kinds of toy cars such as toy cars for displaying, remote-controlled cars, and four-wheel driven cars are sold on the market. The four-wheel driven cars can go very fast if there is a suitable area or track, while the remote-controlled cars can be controlled to go in various fields, thereby interesting both adults and children.

However, the tire of the remote-controlled cars only covers the rim and they are not firmly engaged with each other, so that when the remote-controlled car are driven in an area where sand or stones are present, the sand may go into the gap between the tire and the rim. This will cause a noisy sound and the sand or stone will even go into the tire thereby making the tire uneven in weight of the wheels and therefore rendering it difficult to control and increasing the wearing rate of the tire.

Hence, it has been proposed to seal the gap between the tire and the rim by adhesive agent for preventing sand or stone from entering into the tire. However, it is necessary to lift the tire away from the rim and then apply adhesive agent to the gap in order to join the rim and the tire together. Although this method can prevent sand and/or stone from entering into the tire, a lot of labor work and time are required to perform the process. Furthermore, it is difficult to apply adhesive agent to the gap and the tire is often adhered to the rim at certain points only. Moreover, this method is unfit for mass production.

Accordingly it is an object of the present invention to provide a tire-rimming device which is simple and convenient to carry out and can seal the gap between the tire and the rim.

### SUMMARY OF THE INVENTION

It is the primary object of the present invention to provide a tire-rimming device for toy cars which can completely seal the gap between a rubber tire and a rim.

It is another object of the present invention to provide a tire-rimming device for toy cars which is convenient to use.

It is a further object of the present invention to provide a tire-rimming device for toy cars which is fit for mass production.

Accordingly, it is an object of the present invention to provide a tire-rimming device for a toy car comprising a base seat within a housing and a pressing frame, characterized in that the base seat is provided with a support frame, a rotating plate, a fastening seat and a switch, the center of the rotating plate is provided with a positioning shaft which is connected to a speed-reduction motor within the housing, the side of the housing is provided with a battery chamber and a socket for a transformer; and the center of the pressing frame is provided with a through hole having one end mounted with a connection section, a locking shaft is locked to the support frame of the base seat, and the other end is pivotally connected to a pressing element for mounting with a fastening seat of the base seat.

Yet another object of the present invention is to provide a tire fixing device for toy car, wherein a loop is formed by the switch, the speed reduction motor, the socket for the transformer and the positive and negative terminal of the battery chamber.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is a sectional view of the present invention.

FIG. 3 is a partial enlarged view of the present invention.

FIG. 4 is another application in accordance with the present invention.

FIG. 5 is a sectional view of FIG. 4 of the present invention.

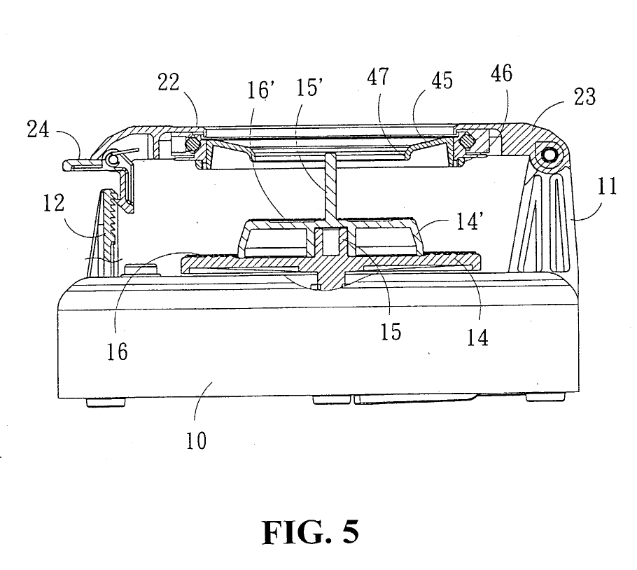

FIG. 6 is a schematic view showing the use of a transformer in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

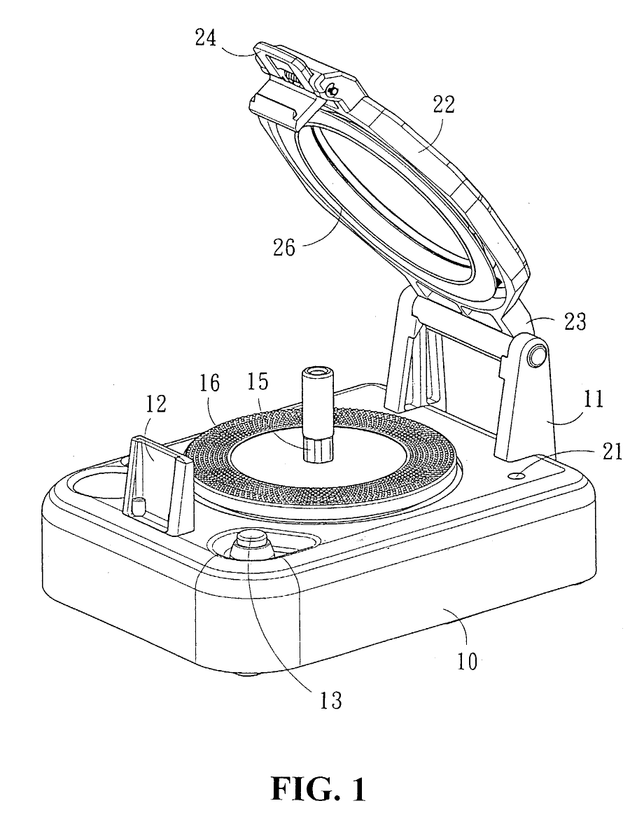

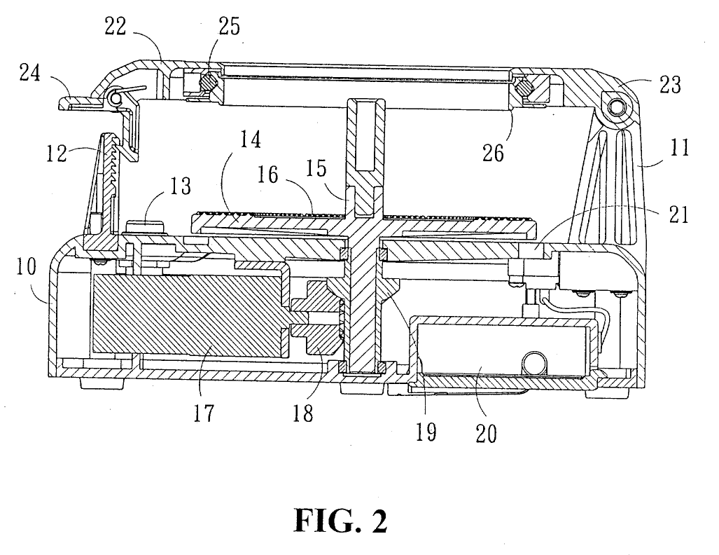

Referring to FIGS. 1 and 2, there is shown a tire-rimming device for a toy car having a base seat 10. The front and rear edges of the surface of the base seat 10 are provided with two support frames 11 and a fastening seat 12. The fastening seat 12 is formed with a toothed inner side. The base seat 10 is provided with a switch 13 and a rotating plate 14 and the surface of the rotating plate is a rough surface 16. The center of the rotating plate 14 is downwardly protruded with a positioning shaft 15, and the positioning shaft 15 passes through the surface of the base seat 10 and reaches the interior of the base seat 10. The positioning shaft 15 is mounted with a bevel gear 19 which is in engagement with the pinion gear 18 of the speed reducing motor 17, and the side of the base seat 10 is a batter chamber 20 and a socket 21 for a transformer. The positive and negative terminal of the battery chamber 20 forms a loop with the socket 21, the switch 12 and the speed reducing motor 17. The support frame 11 of the base seat 10 employs a locking shaft and a torsional spring to lock to the connection portion 23 at one end of the pressing frame 22. The center of the pressing frame 22 is provided with a through hole, and the other end of the pressing frame 22 employs a locking shaft and a torsional spring to lock onto a pressing element 24. The pressing element 24 is L-shape and one end thereof being a hook which can hook to the fastening seat 12. The edge of the through hole of the pressing element 24 is a bearing 25 and the lower edge of the bearing 25 is provided with a protruded lug 26.

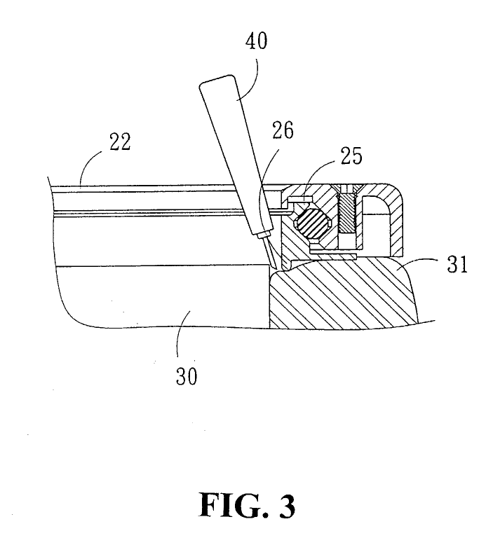

As shown in FIG. 3, the pressing element 24 is pressed downwardly and the hook at the front end thereof is disengaged from the fastening seat 12, and the torsional spring mounted to the locking shaft of the support frame 11 lifts up the pressing frame 22. The wheel center of a toy car is placed to the positioning shaft 15 and the pressing frame 22 is pressed. The pressing element 24 and the fastening seat 12 are fastened, at this moment, the protruded lug 26 of the bearing 25 is exactly pressed to the inner edge of the tire 31 such that the tire 31 and the rim 30 cause a gap to fill with an adhesive 40. The switch 13 is ON and the speed reducing motor 17 is initiated. The pinion gear 18 and the bevel gear 19 are in motion and the rotating plate 14 is driven to rotate. The rough surface 16 on the rotating plate 14 causes the wheel to rotate. By means of the adhesive 40 the gap of the wheel is fully coated with the adhesive 40. At the same time, the revolution of the rotating plate 14 does not require the user to move the adhesive 40 so as to fill the gap.

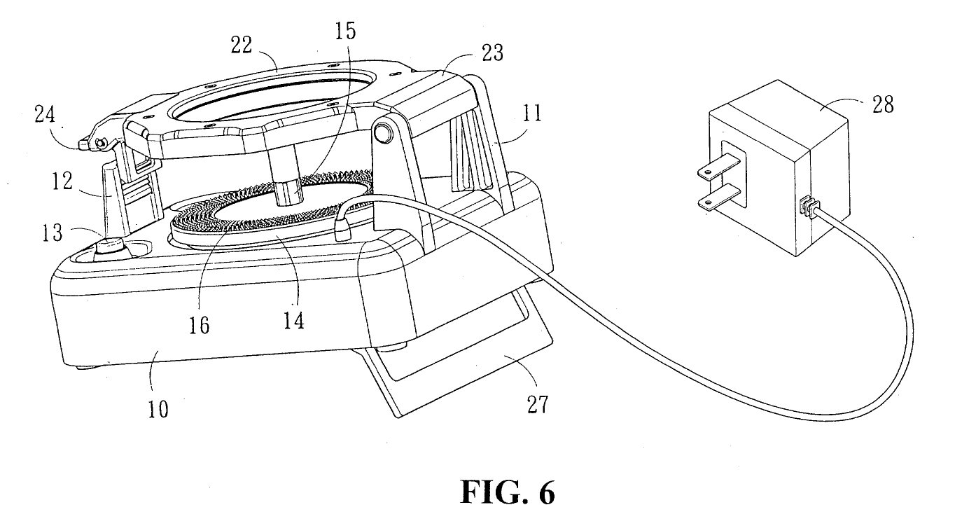

The socket 21 can be connected with a transformer 28 and the AC is converted to DC for the use of the speed reducing motor 17. As shown in FIG. 6, the bottom portion of the base plate 10 is a support 27 which can be folded such that the base plate 10 is provided with a sloping facilitating the coating of the adhesive 40.

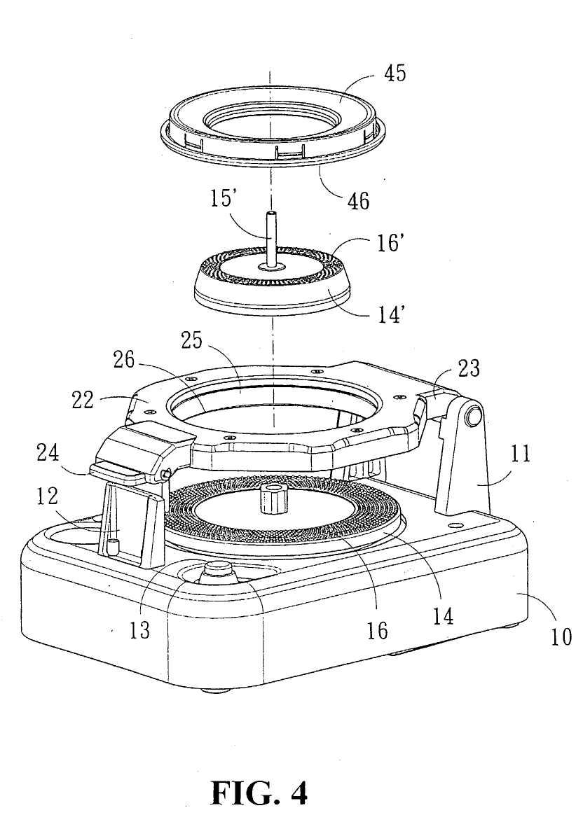

Referring to FIG. 4, if the wheel to be coated with adhesive is small, the protruded lug 26 of the bearing 25 cannot press the inner edge of the small tire. If this is the case, the pressing frame 22 is lifted up and the bottom portion of the small rotating plate 14 is passed through the positioning shaft 15 and is directly stacked onto the rotating plate 14. The small wheel pressing frame 45 is mounted to the protruded lug 26 of the recess 46, and the inner diameter of the small wheel pressing frame 45 has a protruded lug 47. The rotating plate 14 has a small rotating plate 14′; therefore the height thereof is increased. The center of the rotating plate 14 is provided with the positioning shaft 15′ which can hold the small tire. When the pressing frame 22 is depressed, the protruded lug 47 of the small wheel pressing frame is exactly pressed the inner edge of the tire 31 of the small wheel and a gap is formed between the tire and the rim 30 for filing with the adhesive 40. When the switch 13 is pressed, the speed-reducing motor 17 drives the rotating plate 14 such that the adhesive 40 can fully seal the gap.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A tire-rimming device for a toy car, comprising a base seat within a housing and a pressing frame, characterized in that: the base seat is provided with a support frame, a rotating plate, a fastening seat and a switch, the center of the rotating plate is provided with a positioning shaft which is connected to a speed-reduction motor within the housing, the side of the housing is provided with a battery chamber and a socket for a transformer; and the center of the pressing frame is provided with a through hole having one end mounted with a connection section, a locking shaft is locked to the support frame of the base seat, and the other end is pivotally connected to a pressing element for mounting with a fastening seat of the base seat.

2. The tire-rimming device of claim 1, wherein a loop is formed by the switch, the speed-reduction motor, the socket for the transformer and the positive and negative terminals of the battery chamber.

3. The tire-rimming device of claim 1, wherein the surface of the rotating plate is a rough surface.

4. The tire-rimming device of claim 1, wherein the shaft of the speed reduction motor within the base seat is provided with a pinion gear which is engaged with the bevel gear mounted on the positioning shaft.

5. The tire-rimming device of claim 1, wherein the locking shaft of the connection portion and the locking shaft of the pressing element are mounted with a torsional spring.

6. The tire-rimming device of claim 1, wherein the central through hole of the pressing frame is provided with a bearing.

7. The tire-rimming device of claim 6, wherein the bottom edge of the bearing is a protruded lug.

8. The tire-rimming device of claim 1, wherein the protruded lug is fitted with a pressing frame with a recess having an external bottom edge.
